(19) United States
(12) Patent Application Publication
(10) Pub. No.: US 2010/0175820 A1
(43) Pub. Date: Jul. 15, 2010

(54) LIGHT REGULATING FILM, LAMINATED LIGHT REGULATING FILM, AND METHOD FOR PRODUCING LIGHT REGULATING FILM AND LAMINATED LIGHT REGULATING FILM

(75) Inventors: Yoshihiro Uozu, Kanagawa (JP); Jun Nakauchi, Tokyo (JP); Masatoshi Toda, Tokyo (JP); Tetsuya Sawano, Hiroshima (JP); Hiroki Hatakeyama, Hiroshima (JP)

Correspondence Address: MORGAN LEWIS & BOCKIUS LLP, 1111 PENNSYLVANIA AVENUE NW, WASHINGTON, DC, 20004, US

(73) Assignee: Mitsubishi Rayon Co., Ltd.

(21) Appl. No.: 12/688,081

(22) Filed: Jan. 15, 2010

Related U.S. Application Data
(62) Division of application No. 12/081,676, filed on Apr. 18, 2008, now abandoned.
Application No. 12/081,676 is a continuation of application No. PCT/JP2006/320854, filed on Oct. 19, 2006.

(30) Foreign Application Priority Data
Oct. 20, 2005 (JP) 2005-306063

(51) Int. Cl. B29D 11/00; B29D 7/01; B29C 59/02; B29C 59/16; B29C 59/00; B32B 37/00

(52) U.S. Cl. 156/242; 264/2.7; 264/2.1; 264/1.36; 264/2.6; 264/1.6

(57) ABSTRACT

Linear notch patterns at fixed intervals are formed by contacting blades 6a on a drum 6 with a film F and mechanically transferring the shape of the blades 6a to the film F. The notch pattern is formed to be approximately parallel to the axial direction of the drum 6. When a flexural stress is applied in the direction of the film F transport by passing the film over the bending roll 8 while applying a predetermined tension thereto, crazes or cracks are formed inside the notch patterns, with the notches in the notch patterns serving as starting points thereof. Since crazes or cracks are formed using the notch patterns as starting points, relatively large crazes or cracks can be obtained, and optical characteristics can be controlled at a high level.

This is a divisional application of copending application Ser. No. 12/081,676, filed on Apr. 18, 2008, which is a continuation application of PCT/JP2006/320854, filed on Oct. 19, 2006, which claims priority to JP 2005-306063, filed on Oct. 20, 2005, which are hereby incorporated by reference.

### TECHNICAL FIELD

The present invention relates to a light regulating film capable of controlling optical properties such as transmissivity and scattering and used as a visual field selection film, an anisotropic light scattering film, or the like, and to laminated light regulating films constituted to include this laminated light regulating film, and to a method for producing light regulating film and a method for producing laminated light regulating film.

### Technical Background

Various light regulating films capable of controlling optical properties such as transmissivity and scattering and used as visual field selection films, anisotropic light scattering films, and the like are known.

Known methods for producing such light regulating film include, for example, the method for producing whereby resin sheets or films containing a light absorbing substance or light scattering substance are alternately laminated with transparent resin to form a block, and said block is then sliced to produce a louvered film (Patent Citation 1).

In another known producing method (Patent Citation 2), a linear ultraviolet beam is irradiated onto a membrane-shaped ultraviolet-hardening composition from a predetermined angle to harden the ultraviolet-hardening composition, then a second ultraviolet-hardening composition is held on top of the hardened ultraviolet-hardening composition and a linear ultraviolet beam is irradiated thereon from a different angle to harden the second ultraviolet-hardening composition, resulting in a sheet in which portions differing in optical characteristics in a direction perpendicular to the sheet thickness direction are laminated together.

Another known method for producing film capable of controlling optical properties such as transmissivity and scattering is to scrape a transparent resin film with a blade to form crazes within the film, then cause light absorbing substances or light scattering substances to penetrate into these crazes.

Patent Citation 1: JP S.63-190683

Patent Citation 2: JP S.63-309902

Patent Citation 3: JP H.06-82607

### DISCLOSURE OF THE INVENTION

### Problems to Be Solved by the Invention

However, the method described in Patent Citation 1 is problematic in that the producing process is cumbersome, productivity is low, and the resulting film product cost is high. It is also problematic in that reducing the thickness of the light absorbing layer or the dispersion layer is difficult; hence light transmissivity is poor.

The method described in Patent Citation 2 is problematic in that the border between regions with differing refractive indices is not sharp in the produced film; therefore light transmissivity and scattering cannot be sufficiently controlled.

Furthermore, while said optical film can be very easily fabricated using the method in Patent Citation 3, the film surface therein can be easily scratched by the operation in which a blade scrapes the film. Also, because of the requirement to precisely control the scraping pressure applied by the blade, there is a further limitation in that the blade must be precisely positioned.

To resolve these problems, a method has been recently described in JP H.09-281306 whereby cracks with a regular directionality are formed by applying stress to a non-oriented light transmissive polymer film. With this method, however, the position at which cracks are formed cannot be controlled, and the cracks formed are extremely small, making it difficult, for example, to effectively introduce substances with differing optical properties into those areas, which in turn makes it difficult to obtain a high degree of light regulation.

The present invention was undertaken to resolve the above-described problems, and has the object of providing a light regulating film and a laminated light regulating film with relatively large positionally controlled crazes or cracks, capable of controlling optical properties such as transmissivity and scattering to a high degree, as well as a method for producing a light regulating film and method for producing a laminated light regulating film.

### Means for Solving the Problems

In order to achieve the above objects, the light regulating film of the present invention comprises crazes or cracks formed starting at a plurality of starting point portions disposed in a predetermined pattern on the surface of a film material.

In the present invention thus constituted, the fact that crazes or cracks are formed starting at starting point portions makes it possible to obtain larger (deeper) crazes or cracks. The introduction of substances with differing optical properties into crazes or cracks is thus facilitated, for example, such that optical properties and the like can be easily improved. Also, because crazes or cracks are formed starting at starting point portions, positional aspects of the craze or crack formation, such as formation intervals, formation directionality, and the like can be controlled by forming the starting point portions at desired intervals or densities. As a result, optical properties of the light regulating film, such as transmissivity and scattering, can be controlled to a high degree.

In the present invention, the starting point portions are preferably linear.

In the present invention thus constituted, the starting point portions are formed in a linear shape, therefore crazes or cracks are formed at these linear starting point portions. Positional aspects of the craze or crack formation, such as formation intervals, formation directionality, and the like can thus be controlled by forming the starting point portions at desired intervals or densities. As a result, optical properties of the light regulating film, such as transmissivity and scattering, can be controlled to a high degree.

In the present invention, crazes or cracks are preferably formed to extend from the linear starting point portions in the direction of film material thickness.

In the present invention thus constituted, crazes or cracks are formed to extend from starting point portions in the direction of film material thickness, therefore craze or crack forming patterns are formed in correspondence to a starting point pattern. The crazes or cracks can thus be formed at desired intervals and at desired positions by controlling the formation pattern of starting point portions. Optical properties of the light regulating film can thus be controlled to a high degree.

In the present invention, crazes or cracks are preferably formed to extend in a direction intersecting the direction in which the linear starting point portions extend.

In the present invention, crazes or cracks are preferably formed to extend in a direction approximately perpendicular to the direction in which the linear starting point portions extend.

In the present invention, the starting point portions are preferably dots.

In the present invention thus constituted, the starting point portions are dots, therefore crazes or cracks are formed starting at these dots (starting point portions). Hence aspects of the formation pattern such as the intervals between crazes or cracks or the like can be controlled by adjusting the intervals or the like between the dots. As a result, optical properties of the light control film can be controlled to a high degree. Also, because crazes or cracks are formed in correspondence to a dot pattern, said crazes or cracks can be formed at any desired point and at any desired density. Crazes or cracks can therefore be formed at differing densities and patterns within a single light regulating film.

In the present invention, a plurality of starting point portions is preferably formed at fixed intervals.

In the present invention thus constituted, a plurality of starting point portions is formed at fixed intervals, therefore craze or crack patterns can be easily formed at fixed intervals corresponding to the starting point portions. Light regulating film optical properties can thus be controlled easily and to a high degree. Also, because starting point portions are formed at fixed intervals, the process for forming starting point portions in a predetermined pattern can be easily implemented, and the manufacturing process simplified.

In the present invention, crazes or cracks formed starting at one starting point portion are preferably independent of crazes or cracks formed starting at an adjacent starting point portion.

In the present invention thus constituted, crazes or cracks are independent of crazes or cracks formed starting at an adjacent starting point portion, therefore the surface dimensions of individual crazes or cracks are extremely small. Optical properties of the light regulating film can thus be finely controlled.

In the present invention, crazes or cracks formed starting at one starting point portion preferably connect to crazes or cracks formed starting at an adjacent starting point portion.

In the present invention thus constituted, crazes or cracks connect to the crazes or cracks formed starting at an adjacent starting point portion, therefore the surface dimensions of a single craze or crack are large. Optical properties of the light regulating film can thus be favorably controlled; the introduction of substances with differing optical properties into the crazes or cracks is facilitated, and light controllability and the like can be improved.

In the present invention, the starting point portions preferably comprise a first starting point portion and a second starting point portion, and the crazes and cracks comprise a first craze or crack formed starting from the first starting point portion, and a second craze or crack formed starting from the second starting point portion and extending in a direction intersecting the first craze or crack.

In the present invention thus constituted, the crazes or cracks have mutually intersecting first and second crazes or cracks, therefore the optical properties of the light regulating film can be controlled in two directions, thus enabling a higher level and more accurate control.

In the present invention, the crazes or cracks preferably comprise first crazes or cracks formed starting from starting point portions, and second crazes or cracks starting at the first crazes or cracks and formed to extend in a direction intersecting the first crazes or cracks.

In the present invention thus constituted, the crazes or cracks have mutually intersecting first and second crazes or cracks, therefore the optical properties of the light regulating film can be controlled in two directions, thus enabling a higher level and more accurate control. Also, because the second crazes or cracks are formed starting at the first crazes or cracks, there is no need to separately form starting point patterns for the second crazes or cracks, thus simplifying the light regulating film manufacturing process and shortening manufacturing time. It is also preferable in the present invention for the first crazes or cracks and the second crazes or cracks to be approximately perpendicular.

In the present invention, crazes or cracks are preferably filled with a substance having optical properties different from the film material.

In the present invention thus constituted, a substance having optical properties differing from the film material is filled into the crazes or cracks, thus enabling the provision of a light regulating film with superior optical properties such as viewing angle properties, transmissivity, and the like.

In the present invention, the film material preferably has an Izod impact strength (ASTM D256) of not more than 40 J/m, a flexural modulus (ASTM D790) of 2950 Mpa or greater, and a thickness of not more than 0.35 mm; and crazes or cracks are formed by application of flexural deformation using a bending radius r/d<30 (r=bending radius; d=film material thickness) under a tension of not more than 10 N/cm.

In the present invention thus constituted, formation of crazes or cracks by flexural deformation of a film material with an Izod impact strength (ASTM D256) of not more than 40 J/m, a flexural modulus (ASTM D790) of 2950 Mpa or greater, and a thickness of not more than 0.35 mm allows for the formation of crazes or cracks with extremely sharply defined shapes at a uniform pitch.

Crazes or cracks have difficulty starting when the Izod impact strength of the film material used is larger than 40 J/cm, due to the inherent impact strength of the resin. In actuality, application of a tension larger than 10 N/cm to the film material while applying a flexural deformation enables intermittent formation of extremely small crazes or cracks even in film materials with an Izod impact strength greater than 40 J/cm, but in such cases the craze or crack dimensions are too small, and desired optical properties are not obtained. When tension is greater than 10 N/cm, the problem of susceptibility to scratching on the back side of the film material occurs due to rubbing and the like during transport.

When the flexural modulus of the film material being used is 2900 Mpa or less, the film material can tear while applying a flexural deformation, making stable manufacture impossible.

Specifically, films such as non-cross linked or partially cross-linked methacrylic resin, styrene resin, amorphous polyolefin resin, ultraviolet-hardening transparent resin, and heat-hardening transparent epoxy resins are preferred.

When the thickness of the film material is larger than 0.35 mm, the amount of deformation on the inside and outside surfaces becomes too large, making it difficult to apply flexural deformation. Furthermore, a film material thickness of 0.30 mm or below is preferable when consideration is given to process stability. When the thickness is less than 5 μm, on the other hand, it becomes difficult to form a thin film uniformly, and in reality formation of uniform crazes or cracks is extremely difficult. Also, a thickness of 10 μm or greater is preferable for stable formation of shapes.

The laminated light regulating film of the present invention comprises a base material film together with the previously described light regulating film laminated onto said base material film.

In the present invention thus constituted, a laminated light regulating film comprises the above-described light regulating film, therefore the same result can be obtained as for the above-described light regulating film; the forming position of the crazes or cracks can be controlled, relatively large crazes or cracks can be formed, and optical properties such as transmissivity and scattering can be controlled to a high degree.

The method for producing the light regulating film of the present invention comprises a step for forming a plurality of starting point portions in a predetermined pattern on the surface of a film material, and a step for forming crazes or cracks starting from the starting point portions.

In the present invention thus constituted, crazes or cracks are formed starting at the starting point portions, therefore larger (deeper) crazes or cracks can be obtained. It therefore becomes easier, for example, to introduce substances with differing optical properties into the crazes or cracks, thus facilitating improvements in light controllability and the like. Also, because crazes or cracks are formed starting at starting point portions, formation positional aspects such as craze or crack formation intervals and formation directionality can be controlled by forming the starting point portions at desired intervals or densities. As a result, optical properties of the light regulating film, such as transmissivity and scattering, can be controlled to a high degree.

In the present invention, the step for forming the starting point portions is preferably a step in which a mold corresponding to starting point portions is impressed on the surface of the film material.

In the present invention thus constituted, the step for forming the starting point portions is a step of impression with a mold; starting point portions can therefore be formed by a simple operation. Also, because the mold is formed in correspondence to the starting point portions, the pattern of starting point portions can be accurately formed in the film material.

In the present invention, the mold is preferably a drum with protuberances formed on its outer circumference.

In the present invention thus constituted, because the mold is a drum with protuberances formed on its outer circumference, starting point portions can be easily formed by impressing the drum on the film material while the drum is being rotated. Also, because the mold is a drum, the light regulating film can be continuously manufactured, and productivity is improved.

In the present invention, the step for forming the starting point portions is preferably one in which scars are made in the film material using blades corresponding to starting point portions.

In the present invention thus constituted, the starting point portions are formed by scarring the film material with a blade, therefore starting point portions can be formed in a simple manner.

In the present invention, the step for forming the starting point portions is preferably one in which properties of the parts of the film material corresponding to the starting point portions are varied.

In the present invention thus constituted, the starting point portions are formed by varying the properties of the parts of the film material corresponding to the starting point portions, therefore starting point portions can be formed without scarring the film material, in contrast to the case in which starting point portions are formed by a physical process. Also, because the starting point portions are formed by varying the properties of the film material, formation patterns of the starting point portions can be controlled with a high degree of accuracy.

In the present invention, the step for varying the properties preferably includes a step for covering the film material with a mask having a predetermined pattern and irradiating it with electromagnetic radiation.

Alternatively, in the present invention the step for varying properties preferably includes a step for adhering an organic solvent to the parts corresponding to the starting point portions on the surface of the film material.

In the present invention, the starting point portions are preferably dots.

In the present invention thus constituted, the starting point portions are dots, therefore crazes or cracks are formed using these dots (starting point portions) as starting points. Thus formation patterns such as the intervals between crazes or cracks and the like can be controlled by adjusting parameters such as dot intervals or the like. Optical properties of the light regulating film can thus be controlled to a high degree. Also, because crazes or cracks are formed in correspondence to a dot pattern, crazes or cracks can be formed at any desired point and any desired density. It is therefore possible to form crazes or cracks at differing densities and patterns within a single light regulating film.

In the present invention, the starting point portions are preferably linear.

In the present invention thus constituted, the starting point portions are formed in a linear shape, therefore crazes or cracks are formed starting from these linear starting point portions. Thus positional aspects of the craze or crack formation, such as formation intervals, formation directionality, and the like, can be controlled by adjusting the intervals or the like between linear starting point portions. Optical properties of the light regulating film can thus be controlled to a high degree.

In the present invention, the film material is preferably of an elongated shape, and the linear starting point portions extend in the longitudinal direction of said elongated film material.

Alternatively, the film material of the present invention preferably has an elongated shape, and the linear starting point portions extend at an angle relative to the longitudinal direction of said elongated film material.

In the present invention, the step for forming crazes or cracks is preferably accomplished by applying flexural stress while applying tension to the film material.

In the present invention thus constituted, because crazes or cracks are formed by applying flexural stress while applying tension to the film material, crazes or cracks can be formed by a simple process.

In the present invention, the step for forming the crazes or cracks preferably includes a step for applying flexural stress to the film material in a direction approximately perpendicular to the direction in which the linear starting point portions extend.

In the present invention thus constituted, because flexural stress is applied to the film material in a direction approximately perpendicular to the direction in which the linear starting point portions extend, the crazes or cracks can be formed in a direction approximately perpendicular to the direction of flexing, i.e., in a direction approximately perpendicular to the direction in which the linear starting point portions extend.

In the present invention, the step for forming the crazes or cracks preferably includes a step for applying flexural stress to the film material in a direction approximately parallel to the direction in which the linear starting point portions extend.

In the present invention thus constituted, flexural stress is applied to the film material in a direction approximately parallel to the direction in which the linear starting point portions extend, therefore the crazes or cracks are formed in a direction approximately perpendicular to the flexing direction, i.e. along the direction in which the linear starting point portions extend. Therefore crazes or cracks can be formed in approximately the same pattern as the starting point portions.

In the present invention, the step for forming crazes or cracks includes a step for applying flexural stress to the film material in a direction approximately perpendicular to the direction in which the linear starting point portions extend.

In the present invention thus constituted, because flexural stress is applied to the film material in a direction approximately perpendicular to the direction in which the linear starting point portions extend, the crazes or cracks can be formed in an array along the direction in which the linear starting point portions extend, approximately perpendicular to the flexing direction.

In the present invention, the step for forming the starting point portions preferably includes a step for forming a first starting point portion and a step for forming a second starting point portion, and the step for forming crazes or cracks includes a step for forming first crazes or cracks starting from the first starting point portion, and a step for forming second crazes or cracks starting from the second starting point portion and extending in a direction intersecting the first crazes or cracks.

In the present invention thus constituted, because the first and second crazes or cracks are formed in mutually intersecting directions, the optical properties of the light regulating film can be controlled in two directions, thus enabling a higher level and more accurate control.

The present invention preferably further comprises a step whereby, using crazes or cracks as a starting point, second crazes or cracks are formed so as to extend in a direction intersecting the direction in which said crazes or cracks extend.

In the present invention thus constituted, because the first and second crazes or cracks are formed in mutually intersecting directions, the optical properties of the light regulating film can be controlled in two directions, thus enabling a higher level and more accurate control. Also, because the second crazes or cracks are formed starting at the first crazes or cracks, there is no need to separately form starting point patterns for the second crazes or cracks, thus simplifying the light regulating film manufacturing process and shortening manufacturing time. It is also preferable in the present invention for the first crazes or cracks and the second crazes or cracks to be approximately perpendicular.

In the present invention, the film material has an Izod impact strength (ASTM D256) of not more than 40 J/m, a flexural modulus (ASTM D790) of 2950 Mpa or greater, and a thickness of not more than 0.35 mm, and the crazes or cracks are formed by application of flexural deformation using a bending radius r/d<30 (r=bending radius; d=film material thickness) under a tension of not more than 10 N/cm.

In the present invention thus constituted, formation of crazes or cracks by flexural deformation of a film material with an Izod impact strength (ASTM D256) of not more than 40 J/m, a flexural modulus (ASTM D790) of 2950 Mpa or greater, and a thickness of not more than 0.35 mm allows for the formation of crazes or cracks with extremely sharply defined shapes at a uniform pitch.

The present invention preferably further comprises a step for filling the crazes or cracks with a substance having optical properties different from those of the film material.

Because the present invention thus constituted further comprises a process for filling the crazes or cracks with a substance having optical properties different from those of the film material, a light regulating film with more varied optical properties can be obtained.

In the present invention, the step for filling using the substance with differing optical properties preferably includes a step for immersing the film material in a liquid material containing a substance having optical properties different from those of the film material.

In the present invention thus constituted, because said substance is filled into the crazes or cracks by immersing the film material in a liquid material containing a substance having optical properties different from the film material, the step for filling with a substance having differing optical properties is easily performed.

In the present invention, the step for forming crazes or cracks is preferably performed in a state whereby film material is immersed in a liquid material containing a substance having optical properties different from those of the film material.

In the present invention thus constituted, because the step for forming crazes or cracks is performed in a state whereby film material is immersed in a liquid material containing a substance with differing optical properties, the step for forming crazes or cracks can be performed at the same time as the step for filling the formed crazes or cracks with a substance having optical properties different from those of the film material. This allows the manufacturing process to be simplified and manufacturing time to be reduced.

The method for producing a laminated light regulating film of the present invention comprises a step for laminating a base material film together with a light regulating film produced by the above-described light regulating film producing method.

In the present invention thus constituted, a laminated light regulating film is produced using a light regulating film produced by the above-described light regulating film producing method, therefore the same results are obtained as for the above-described light regulating film producing method; relatively large crazes or cracks can be obtained, and optical properties such as transmissivity and scattering can be controlled to a high degree.

### Best Mode for Practicing the Invention

### First Embodiment

Referring to the attached figures, we discuss below a first embodiment light regulating film and producing method thereof according to the present invention. FIG. 1 schematically depicts a portion of a light regulating film manufacturing device 1 using the producing method for the light regulating film of the first embodiment of the present invention.

A manufacturing device 1 comprises a craze forming device 2 for forming crazes or cracks on a film surface. As shown in FIG. 1, starting from the upstream side along the longitudinal film F direction of transport shown by arrow A, the craze forming device 2 comprises a supply roll 4 wound with the film F, a drum 6 serving as a starting point pattern device for forming notches which will become starting point portions for crazes or cracks in a predetermined pattern on the surface of the film F, a bending roll 8 for applying flexural deformation to the film F to form crazes or cracks, and a take-up roll 10 for taking up the film F in which crazes or the like are formed. A torque motor is attached to the supply roll 4 wound with the film F to control the tension present when the film is transported.

The drum 6 is a cylindrical metal piece longer in length than the width of the film F, and is constituted to be rotatable around a longitudinal axial line X. As is schematically depicted in FIG. 1, a plurality of blades 6a extending parallel to the axial direction thereof are regularly arrayed over the entire outer surface of the drum 6. In the manufacturing device 1 of the present embodiment, the blades 6a have a triangular cross section, and are arrayed in parallel at a pitch of approximately 25 μm. The pitch of the notches formed can be changed by using drums of differing pitches.

Guide rolls 12 and 14 are respectively disposed on the upstream and downstream sides of the drum 6, and the longitudinal film F transported from the supply roll 4 is pressed with a predetermined force into the blades 6a on the outer circumferential surface of the drum 6.

As described above, the drum 6 is rotatable around a longitudinal axial line X, and therefore rotates at the same speed as the film F transport speed, transferring (forming) notches at a fixed interval in a pattern corresponding to the blades 6a in the surface of the film F being pressed into the blades 6a on the outer circumference surface.

As described above, the blades 6a in the manufacturing device 1 of the present embodiment are arrayed in parallel at a pitch of 25 μm, therefore notches are formed in the longitudinal film F by the drum 6, extending over the entire width of the film F in a direction approximately parallel to the axial direction of the drum 6 at approximately 25 μm intervals, and a notch pattern is transferred to the surface of the film F by these mutually approximately parallel linear notches.

At this point, the tension applied to the film F is preferably 5-100 N per a width of 1 cm. When tension is less than 5 N, crazes or cracks may not form on the film F; when over 100 N, crazes or cracks may form starting at parts other than the notches. In actuality, the applicable tension range varies according to the notch spacing, so it is necessary to adjust the tension as appropriate according to that spacing. Additionally, a film F take-up speed of 5 cm/min or greater is preferable.

There are no particular limitations on the film F so long as it allows for the formation of notches using the blades 6a provided on the drum 6, and for the formation of crazes or cracks with notches as starting points as the result of the application of tensile stress and/or flexural stress; however non-crystalline polymer materials are preferable from the standpoint of controllability of the crazes or cracks.

Specific film F materials include films of non-cross linked or partially cross-linked methacrylic resin, styrene resin, styrene acrylonitrile resin, polycarbonate resin, amorphous polyolefin resin, ultraviolet-hardening transparent resin, and heat-hardening transparent epoxy resin.

It is also preferable for the film F thickness to fall within a range of 5 μm or greater to 500 μm or less, and more preferably within a range of 10 μm or greater to 200 μm or less. Formation of such a thin film uniformly becomes difficult at a thickness is 5 μm or less, making the formation of uniform crazes or cracks realistically extremely difficult. Deformation of the film by flexural stress becomes difficult a thickness of 500 μm or greater, making it difficult to form crazes or cracks which penetrate in the film thickness direction.

A compound sheet may also be used as the film F, in which film made of the type of materials described above is laminated onto a transparent resin film. Transparent resin films for use in such instances include transparent films such as polyester resin, methacrylic resin, polystyrene resin, acrylonitrile styrene resin, amorphous polyolefin resin, and polycarbonate resin.

In the present embodiment, the film F is preferably transported under a tension of 10 N/cm or less. A film with an Izod impact strength (ASTM D256) of 40 J/m or less, a flexural modulus (ASTM D790) of 2950 Mpa or greater, and a thickness of 0.35 mm or less is used as the film F.

The bending roll 8 is disposed on the downstream side of the guide roll 14; it bends the film F transported in the direction shown by arrow A along its outer circumference so that the surface on which notches are formed faces outward; a bending radius of r/d<3 is achieved (r=bending radius; d=film thickness), and flexural stress is applied to the film F to form crazes or cracks. Therefore crazes or cracks are formed in the film F by passing over the bending roll 8. At this point tension and flexural stress are applied to the film F along the direction of film F transport A, and crazes or cracks are formed in the film F starting at the notches. Each notch is formed in a direction approximately perpendicular to the direction of the film F transport, i.e. in a direction approximately parallel to the axis of the bending roll 8, therefore crazes or cracks are formed within the notches, i.e. in the film F thickness direction starting at the position at which the notches are formed, and are formed successively at intervals of approximately 25 μm in a direction approximately parallel to the axial direction of the bending roll 8 over the entire width of the film F.

A metal cylindrical member with a 6 mm outer diameter is used in the present embodiment as the bending roll 8, but a cylindrical member of another dimension may also be used.

A fixed bending guide for bending the transported film F path along a bending radius of r/d<30 (r=bending radius; d=film thickness) can also be used in place of the bending roll 8.

A take-up roll 10 for winding film F′ on which crazes or cracks are formed is disposed on the downstream side of the bending roll 8, and a guide roll 16 is provided between the bending roll 8 and the take-up roll 10.

The supply roll 4, the bending roll 8, the take-up roll 10, and the guide rolls 12, 14, and 16 are all rotatable so that the film F can be transported in sequence from the supply roll 4 to the take-up roll 10.

The light regulating film manufacturing device 1 comprises a craze filling device 20 for filling in crazes or cracks on a film F′ containing crazes or cracks with a substance having optical properties different from the film F′, such as a light absorbing substance and a transparent resin with an refractive index different from the film F′.

FIG. 2 is a diagram schematically showing the constitution of the craze filling device 20. The craze filling device 20 is provided on the downstream side of the craze forming device 2.

Starting from the upstream side along the direction of film transport shown by arrow B, the craze filling device 20, as shown in FIG. 2, comprises a supply roll 22 for feeding the craze-bearing wound film F′, a first guide roll 24, an immersion bath 26 for holding a liquid material L including a filler substance, a second guide roll 28 disposed within the immersion bath 26, a third guide roll 30 disposed above the immersion bath 26, a pair of cleaning rolls 32 and 34, a heating device 36, and a winding roll 38.

Each of the rolls 22, 24, 28, 30, 32, 34, and 38 in the craze filling device 20 is capable of rotating in order to transport the craze-bearing film F′ so that it is transported in the direction shown by arrow B.

In the present embodiment, pigment or dye is selected as the liquid material L filling substance, but selection may additionally be made from among light absorbing substances such as carbon nanotubes, fullerene, and metal nanoparticles, low refractive index chlorine polymers with an refractive index different from that of the film material, high refractive index sulfur-containing polymers, or other resins with refractive indices different from the film material. Such filling substances are assumed to be of a particle size capable of being filled in the spaces of crazes or cracks.

In the present embodiment the liquid material L contains heat-hardening compositions, but solvents which do not dissolve the film constituent resin material or ultraviolet-hardening compositions may also be contained in place of the heat-curing compositions.

The cleaning rolls 32 and 34 wipe off excess liquid material L adhering to the surface of the film F′ with crazes or cracks in the immersion bath 26. A doctor blade with the function of removing liquid material may also be used instead of the cleaning rolls 32 and 34.

The heating device 36 blows a hot air stream onto the film F′ immersed in the liquid material L within the immersion bath 26, causing heat-hardening compositions in the liquid material L penetrating the crazes in the craze-bearing film F′ to harden, thus affixing the filling substances in this liquid material within the crazes. When a light(ultraviolet)-hardening compositions as the liquid material for the liquid material (immersion liquid) L are selected, a light(ultraviolet) irradiating device is disposed in place of the heating device to harden the ultraviolet-hardening compositions in the liquid material L penetrating the crazed in the craze-bearing film F′ by ultraviolet light, and affix the filling substances in this liquid material within the crazes.

When a solvent is used, the solvent is sublimated and the filling substance is affixed within the cracks.

To avoid forming new crazes or cracks, it is preferable for the filling step performed by the craze filling device 20 to be performed at a lower tension than the step for forming crazes or cracks by the craze forming device 2; e.g. in a state whereby the film F′ with crazes is under a tension of 0.5 N or below.

The bending curvature of the second guide roll 28 is preferably greater than the bending curvature for forming crazes using the drum 6; i.e. greater than the bending curvature of the bending roll 8. Note that at the second guide roll 28, the film F′ with crazes is disposed so that the side on which crazes are formed faces outward.

In the craze filling device 20 thus constituted, transporting the film F′ with crazes through the liquid material L in the immersion bath 26 causes the liquid material L containing the filling substance in the immersion bath 26 to penetrate into the crazes in the craze-bearing film F′. At that point, the liquid material L penetrates into the notch patterns.

Thereafter, the liquid material L containing the filling substance used to penetrate into the crazes is hardened by the heat-hardening device 36, so that the filling substance is affixed in a state whereby it is filled into the crazes.

The following effects are obtained using the first embodiment described above.

Crazes or cracks are formed starting at notches in a notch pattern, therefore compared to prior such products, larger crazes or cracks can be obtained. It is therefore easier to fill in substances with optical properties different from the film F material, thus enabling improved light regulation.

Also, because crazes or cracks are formed starting at notches disposed in a predetermined pattern, the formation intervals of the crazes or cracks can be easily controlled by adjusting the notch forming interval or shape. Therefore optical properties of the light regulating film can be controlled to a high degree.

Because crazes or cracks are formed within the notches from only the notch forming positions in the direction of thickness of the film F, the direction in which the crazes or cracks form, the formation pattern, and the like can be adjusted by adjusting the notch pattern. Therefore optical properties of the light regulating film can be controlled to a high degree.

Because the notches are formed in a linear shape at fixed intervals, notches can be easily obtained in the film F by pressing the film F onto the drum 6 while rotating the drum 6. Since the crazes or cracks are also formed in a linear shape at fixed intervals by this means, the formation of crazes or cracks can be reliably controlled, and sharp visual field controllability can be obtained.

Because the notches are mechanically transferred by the drum 6, they can be easily formed. Also, transfer can be effected by rotating the drum 6, therefore continuous production can be easily achieved.

Because the liquid material L is filled into the crazes or cracks, controllability of the light regulating film can be dramatically improved. Notch width dimensions are formed in the present embodiment to be wider than the width dimension of the crazes or cracks; the liquid material L is also introduced into these notches; it is believed that controllability can thus be even further improved.

Note that the film F′ in which the crazes or cracks are formed may also be a laminated light regulating film in which transparent resin films such as those described above are laminated into a compound sheet.

### Second Embodiment

Next we discuss a second embodiment light regulating film and producing method thereof according to the present invention. The second embodiment light regulating film and producing method thereof differ from the first embodiment light regulating film and producing method thereof in that the steps for forming the crazes or cracks and for filling with a liquid material are performed simultaneously.

FIG. 3 depicts a light regulating film manufacturing device 40 according to the second embodiment of the present invention. In the manufacturing device 40 of the present embodiment, the bending roll 8 is disposed inside the immersion bath 26 which holds the immersion liquid L.

The film F in which notches are formed by the drum 6 is further imposed onto the outer circumference of the bending roll 8 disposed within the immersion bath 26 holding the immersion liquid L, and the pathway thereof is bent within the immersion liquid L.

When, as a result of this bending, flexural stress and tensile stress are further applied to the film F along a direction approximately tangential to the bending roll 8 direction, crazes or cracks are caused to occur within the notches starting at the notch. In other words, crazes or cracks are formed at approximately a fixed interval (approximately 25 μm) along a direction which crazed or cracks extend and in a direction approximately parallel to the axial direction of the bending roll 8. As a result of performing the step for forming the crazes or cracks in the film F within the immersion liquid L, the immersion liquid L in the immersion bath 26 penetrates into the formed crazes or cracks at the same time as those crazes or cracks are formed in the film F.

In addition to the same effects as those obtained in the first embodiment, the following effects are also obtained by the second embodiment described above.

The step for forming crazes or cracks is performed at the same time as the step for filling a liquid material into the crazes or cracks, therefore the light regulating film producing process can be simplified, space requirements for the manufacturing device 40 can be reduced, and manufacturing time can be shortened.

Also, because the crazes or cracks can be immersed in the immersion bath 26 in an opened state by the bending roll 8, the liquid material L can be more reliably filled into the crazes or cracks.

### Third Embodiment

Next we discuss a third embodiment light regulating film and producing method thereof according to the present invention. The third embodiment light regulating film and producing method thereof differ from the first embodiment light regulating film and producing method thereof in respect of the direction of formation of the crazes or cracks relative to the direction of notch formation.

FIG. 4 shows a view from below of a drum 6 in a light regulating film manufacturing device 50 according to a third embodiment of the present invention. As the figure shows, the direction of transport of the film F in this embodiment is disposed at an angle of, for example, 45° with respect to the drum 6 tangential direction. When the film F is transported over the drum 6 in this constitution, diagonal linear notches N are formed at an angle with respect to the longitudinal direction of the film F.

Note that such notches N may, for example, also be formed on the outer circumference of the drum 6 by disposing blades at a predetermined angle relative to the longitudinal direction of the film F and impressing the surface of the film F onto this drum 6. Notches N may also be formed by disposing the rotational axis of a drum 6, on which blades are disposed parallel to said rotational axis, at a 45° angle relative to the film F transport direction.

The film F on which notch patterns N are formed is thereafter bent on the outer circumference of the bending roll 8; at this point the film F is disposed so that its longitudinal direction is approximately perpendicular to the axial direction of the bending roll 8. Therefore the direction of the notches N forms a predetermined angle with respect to the axial direction of the bending roll 8.

When the film F is transported along the outer circumference of the bending roll 8, tension and flexural stress is applied to the surface of the film F, and crazes or cracks are formed on the film F starting at the notches and extending in a direction approximately parallel to the axis of the bending roll 8. Here the notches are formed to extend at an angle with respect to the axis of the bending roll 8, therefore while crazes or cracks are formed starting at the notches, they are formed, as shown in FIG. 5, to extend up to the outside of the notches, at a given angular direction with respect to the direction in which the notches extend. In the present embodiment, the crazes or cracks formed do not connect with adjacent crazes or cracks formed starting at adjacent notches; they are very fine and discontinuous (intermittent), and are independent from crazes or cracks formed starting at adjacent notches. Therefore large numbers of crazes or cracks are formed in a predetermined direction along the linear notches.

In addition to the same effects as those obtained in the first embodiment, the following effects are also obtained by the third embodiment described above.

Crazes or cracks are formed in the film F by application of flexural stress in a direction which intersects the notch forming direction, therefore very fine crazes or cracks are disposed on the film F in the direction of notch formation; these are formed so as to extend in a direction approximately perpendicular to the direction in which flexural stress is applied.

Because the very fine crazes or cracks are formed along the linear notches starting at the notches, the density of the crazes or cracks can also to some degree be controlled by adjusting notch formation density, thereby improving light controllability.

### Fourth Embodiment

Next we discuss a fourth embodiment light regulating film and producing method thereof according to the present invention. The fourth embodiment light regulating film and producing method thereof differ from the third embodiment light regulating film and producing method in that the crazes or cracks are formed in two directions on the surface of the film F.

First, as in the third embodiment, notches with diagonal linear patterns having an angle of, for example, 45° with respect to the tangential direction of the drum 6 are formed in the film F.

Next, the film F is disposed so that the direction in which the notches extend is approximately parallel to the axial direction of the bending roll 8, and flexural stress is applied by the bending roll 8. By applying flexural deformation in a direction approximately perpendicular to the direction in which the notches are formed, continuous first crazes or cracks are formed across the entire width of the film F in the direction in which the notches extend, starting from the notches. The first crazes or cracks are formed diagonally at approximately 45° relative to the longitudinal direction of the film F.

Thereafter, the film F transport direction or the drum 6 angle is changed to approximately 90°, the film F is passed once again through the craze forming device, and the film F is transported in a direction approximately perpendicular to the direction of formation of the first crazes or cracks. When tension and flexural stress is applied to the film F in a direction approximately perpendicular to the direction of formation of the first crazes or cracks, second crazes or cracks are formed starting at the first crazes or cracks in a direction approximately perpendicular to the direction of formation of the first crazes or cracks.

When forming crazes or cracks in a direction approximately perpendicular to the direction in which the notches extend, continuous crazes or cracks are obtained according to notch shape or pitch. For example, when forming continuous crazes or cracks in the film F width direction, the linear notch interval is preferably 75 μm or less. 50 μm or less is even more preferable. When the notch interval is 100 μm or greater, the crazes or cracks formed will be discontinuous. In the present embodiment, as shown in FIG. 6, the second crazes or cracks formed starting at given first crazes or cracks are connected to the second crazes or cracks formed starting at the first crazes or cracks adjacent thereto, and are formed continuously.

In addition to the same effects as those obtained in the third embodiment, the following effects are also obtained by the fourth embodiment described above.

Tension and flexural stress are applied in mutually approximately perpendicular directions to the film F, therefore first crazes or cracks and second crazes or cracks formed in a direction approximately perpendicular thereto are formed in the surface of the film F. A high degree of light controllability in the light regulating film can thus be achieved. In this case, because the first notches are formed for the purpose of forming the first crazes or cracks, the craze or crack intervals can be accurately set.

Because the first crazes or cracks are used as starting points to form the second crazes or cracks, there is no need to form second notches for forming the second crazes or cracks, hence the light regulating film producing process can be simplified and producing time can be shortened.

Notches and crazes or cracks are formed diagonally by inclining the direction of transport of the film F approximately 45° relative to the drum 6 and the bending roll 8, therefore a light regulating film with crazes or cracks formed in two directions can be continuously manufactured, and productivity increased.

### Fifth Embodiment

Next we discuss a fifth embodiment light regulating film and producing method thereof according to the present invention. The fifth embodiment light regulating film and producing method thereof differ from the first embodiment light regulating film and producing method thereof in that the notches are shaped as dots.

FIG. 7 shows a portion of a fifth embodiment light regulating film manufacturing device 60. As shown in FIG. 7, the drum 61 on the manufacturing device 60 differs from the first embodiment, in which the blades are formed along the axial direction of the drum; a large number of dot-shaped protuberances are randomly formed on the outer surface of the drum 61. A substantially uncountable number of dots is randomly formed on the outer surface of the drum 61, arrayed so that adjacent dots do not line up along axis Y of the drum 61.

In such a manufacturing device 60, dot-shaped notches are formed on the film F when the film F is transported as a result of the film F being pressed onto the protuberances on the drum 61. When this film is bent by the bending roll 8, crazes or cracks are formed starting at the dot-shaped notches in a direction approximately perpendicular to the direction in which tension and flexural stress are applied, i.e. along the bending roll 8 axial direction. Crazes or cracks are formed as shown in FIG. 8, discontinuously and independent of the crazes or cracks originating at adjacent notch starting points.

Note that in some cases the crazes or cracks may be continuous with crazes or cracks originating at adjacent starting points, depending on the distance between adjacent notches along the axial direction of the bending roll 8, the bending radius of the bending roll 8, and the like. Also, when the dot array is aligned using intervals sufficiently small along the direction in which the crazes or cracks extend, the crazes or cracks may be formed continuously; if the dot array is not aligned, intermittent, discontinuous crazes or cracks may be formed.

Moreover, such dot-shaped notches were formed by the pressing of the drum 6, but there is no limitation thereto, and notches could be formed by pressing sandpaper or the like into the film, or by using a sandblasting machine, for example.

In addition to the same effects as those obtained in the first embodiment, the following effects are also obtained by the fifth embodiment described above.

Because the starting point portions comprise dot-shaped notches, a desired pattern of notches can be easily formed by pressing the film F onto the drum 6 while rotating the drum 6. Also, because the notches are formed in a dot shape, crazes or cracks are formed in accordance with the bending direction of the bending roll 8. Furthermore, because the notches are formed in a dot shape, the formation density, pattern, and the like of the crazes or cracks can be adjusted by adjusting the density of the notches or the like.

Because crazes or cracks formed at given notches are independent of crazes or cracks formed starting at notches adjacent thereto, very small crazes or cracks can be formed on a relatively small dimension film F surface. In this case as well, crazes or cracks are formed starting at notches, therefore substances with optical properties different from the film F material can be favorably filled into the crazes or cracks.

The present invention is not limited to the embodiments above; for example, the starting point portions may be formed by scratching the film surface with blades. Also, the starting point portions are not limited to notches (concavities) formed in a concave shape by physically deforming a film surface as described in the embodiments above; any method is acceptable so long as it results in starting points from which crazes or cracks originate from the area where a bending deformation is applied to a film.

In other words, the step for forming starting point portions in a predetermined pattern to serve as starting points for forming crazes or cracks may also consist, for example, of forming starting point portions in a film material by inducing a chemical change in the surface layer of a film material, thereby forming a latent image corresponding to a starting point pattern in the film material. This can be accomplished by covering the film material with an aluminum foil mask from which slits of a predetermined width are punched out at a predetermined pitch corresponding to the pattern of starting point portions, and irradiating from above with an active light beam such as ultraviolet or the like.

This method is effective when a methacrylic resin in which main chain breakage occurs under ultraviolet radiation is used as the film material.

In this method, starting point portions are formed by continuously passing through a light irradiating device with a mask covering in place; starting point portions are intermittently formed by using a mask of a desired length optimal for the light component which will ultimately be used, and re-mounting that mask. A mask pattern can also be continuously transferred using a caterpillar-type continuous sheet-form mask and moving the mask pattern at the same speed as that of the film material. A laser light can also be moved at high speed to draw the starting point portions.

Starting point portions can also be formed on a film material by printing a pattern in a film form corresponding to the desired starting point portions using an ink jet printer head to deposit organic solvent matching the starting point portion pattern to be formed, thereby forming a solvent swelling layer on the film. Any volatile solvent capable of dissolving a film base material may be used. Preferred solvents include low boiling point aliphatic ketones such as acetone and 2-butanon; low boiling point chlorine compounds such as methylene chloride and chloroform; various low boiling point ether compounds; aliphatic ethers such as ethyl acetate and methyl acetate; and low boiling point alcohols typified by ethanol and methanol.

The shape and pattern of the starting point portions is not limited to linear patterns at predetermined intervals arrayed approximately in parallel. Shape, dimension, and the like may be freely selected to be, for example, dot shaped or of a continuous or intermittent linear shape, in accordance with the end use of the light regulating film, required specifications, and the like. Therefore starting point portions may also be undulating or curved, for example.

Also, starting point portions are not limited to being formed at fixed intervals in a predetermined direction; formation spacing may be varied within a single film according to the end use of the light regulating film.

The direction in which the crazes or cracks are formed may follow the direction in which starting point portions extend, or may intersect the direction in which starting point portions extend, or may be approximately perpendicular thereto. When crazes or cracks are formed to intersect the direction in which starting point portions extend, intermittent crazes or cracks are obtained depending on the starting point portion shape, pitch pattern, and the like.

Crazes or cracks may be continuous, connecting with crazes or cracks starting at adjacent starting point portions, or they may be formed discontinuously in an intermittent manner. Note that when crazes or cracks are formed starting from starting point portions in the film material thickness direction, the width of the starting point pattern can be larger than the craze or crack width dimension when the starting point pattern is formed by exposure with an active light beam using a mask, or by an ink jet method, for example, due to diffraction effects when light passes through a mask, or to ink bleeding or the like. In such cases, crazes or cracks may not be completely continuously formed within the starting point pattern; however, crazes or cracks are selectively formed within the starting point pattern, and offer the same functionality as when formed continuously.

When first and second crazes or cracks are formed to extend in two directions on a film surface, the first and second crazes or cracks may be disposed to intersect at a given angle rather than being approximately mutually approximately perpendicular.

In addition to the method described in the forth embodiment for forming first and second crazes or cracks, whereby the first crazes or cracks are used as starting points for the second crazes or cracks, a second starting point pattern may also be formed along or at a given angle to the direction of formation of the second crazes or cracks, for example. Forming of this second starting point pattern may be done either before or after forming the first crazes or cracks. The pitch and shape of the second crazes or cracks can thus be accurately controlled by forming a starting point pattern corresponding to second crazes or cracks.

As described in the fifth embodiment, it seems that when forming dot-shaped starting point portions in film, the dot-shaped starting points can be made to serve as starting points for crazes or cracks in both directions by deforming the film by bending it in two different directions.

A conceivable method for forming second crazes or cracks is, for example, to form first crazes or cracks in a continuous film, then preliminarily cut the film to a given length, then form a long film by connecting that film to a supplementary film using double sided adhesive tape or the like, then transporting this resulting film once again through a craze forming device to form second crazes or cracks. Alternatively, film which has been cut to a considerable length after forming the first crazes or cracks could also be subjected to tension and flexural stress in batches while in a curved state.

### Working Examples

Below we discuss details of the present invention by referring to working examples.

Note that, as shown in FIG. 9, evaluation of the working examples and the comparative example was done by measuring transmissivity when parallel beams were made perpendicularly incident to a sheet surface, and measuring transmissivity when parallel beams were made incident at a 60° angle to a sheet surface, then comparing these values.

### Working Example 1

A solution of methacrylic resin (Mitsubishi Rayon, Acrylite L) dissolved in methyl ethyl ketone was coated onto a 125 μm thick, 10 cm wide polyester film using a bar coater, then dried to produce a compound film with a 150 μm thick methacrylic resin coating membrane.

Using this compound film, an aluminum foil mask from which 2 μm wide slits were punched out at a 50 μm pitch was placed over a film material; ultraviolet light was irradiated thereon from above using a high pressure mercury lamp, the surface layer of the film material was chemically changed, and a latent image corresponding to a notch pattern was formed in the film, thereby imparting a notch pattern to the film.

Next, a light regulating film (louvered film) was produced using the compound film as the film F, omitting the step of forming notch pattern by the drum 6 using the craze forming device 1 of FIG. 1. Film was taken up at a take up speed of 56 cm/minute under a tension of 2 N/cm (value measured using an AlfaMirage Quick Mini 25 digital force gauge). The diameter of the bending roll 8 was 6 mm.

This film material was passed through a liquid material using a heat-hardening paint as a liquid material and carbon black as a filling material; after removing liquid material adhering to the surface, a light control film was obtained by heat-hardening the black paint.

In the completed louvered film, the louver spacing had almost exactly the same pitch as the 50 μm notch pattern, and was extremely well controlled. Transmissivity when parallel beams were made perpendicularly incident to the film surface was 82%, whereas transmissivity at an incidence of 60° to the film surface was 0.3%, showing a high transmissivity and extremely sharp visual field controllability.

### Working Example 2

As in Working Example 1, a compound film having a 50 μm thick methacrylic resin coating membrane was fabricated on a polyester film of 125 μm thickness and 30 cm width. Using the craze forming device 2 of FIG. 1, the film was pressed into blades 6a disposed approximately parallel to the axial direction of the drum 6 at a pitch of approximately 25 μm, thereby impressing a linear 25 μm pitch first notch pattern on the film in the take-up direction (transport direction). Thereafter the film was passed through a 4 mm diameter bending roll 8, bent parallel to the notches to add flexural stress, and passed through the bending roll 8 while deforming at an angle of 170° to create first linear crazes at a 25 μm pitch. Transport speed at this time was 40 cm/min, under a tension of 5 N/cm. Note that the diameter of the bending roll 8 was set at 4 mm; this is because when a notch pattern interval is small, as was the case in this working example, some countermeasure is required, such as increasing film tension or reducing the diameter of the bending roll 8. In the present working example, a small interval notch pattern can be formed by using the smaller 4 mm diameter bending roll 8 instead of the 6 mm diameter bending roll 8 in Working Example 1.

The film thus obtained was cut into 30 cm lengths and joined using strong two-sided tape to the previously used continuous polyester film. Then, using the device of FIG. 1 under the same conditions as were used when forming the first linear crazes, a second notch pattern was formed by again inserting notches in a direction approximately perpendicular to the direction of formation of the first linear crazes; second linear crazes were formed under the same conditions by bending the film in parallel to the direction of formation of the notches; using these first and second linear crazes, mutually crossing lattice-shaped crazes were created on the film. Thereafter the strong two-sided tape was removed to obtain a 30 cm×30 cm film having approximately lattice-shaped crazes in an approximately perpendicular direction.

Using Emacol Black C carbon black nano water dispersion fluid manufactured by the Sanyo Pigment Co. as a liquid material, the film material was passed through the liquid material; liquid material adhering to the surface was removed, and water was removed by evaporation, resulting in a light regulating film with carbon black introduced into the crazes therein.

The completed light regulating film exhibited superior transmissivity and sharp visual field control, with a transmissivity of 78% when parallel beams were made perpendicularly incident to the film surface and, for an incidence of 60° to the film surface from directions parallel to the respective craze forming directions, a transmissivity of 1.2% when parallel to the first craze forming direction and 1.3% when parallel to the second craze forming direction.

### Working Example 3

The same handling as used in Working Example 2 was performed on the film fabricated in Working Example 2, except that when forming the second crazes, the craze forming device was applied in a state whereby the first craze forming direction was angled by 40° relative to the longitudinal direction of the film (the bending roll 8 tangential direction). At that point, second crazes comprising very fine crazes were formed in a direction perpendicular to the direction of film transport in a manner following that of the first crazes, as shown in FIG. 10.

As in Working Example 2, carbon black was introduced into the crazes. Anisotropy was confirmed in the completed light regulating film, with a transmissivity of 78% when parallel light beams were made perpendicularly incident on a film surface and, for an incidence of 60° to the film surface, a transmissivity of 1.2% when parallel to the first craze formation direction, and 40.5% when perpendicular to thereto. Transmissivity was superior, and sharp anisotropy of visual field controllability and visual field selectability was exhibited.

### Working Example 4

Using the craze forming device 2 of FIG. 1, the polyester compound film with a 50 μm methacrylic resin coating membrane fabricated in Working Example 2 was passed over the drum 6 at an angle of 45° relative to the take-up direction by changing the positional arrangement of the film relative to the drum 6 as shown in FIG. 4, thereby forming a first notch pattern angled at 45° relative to the film longitudinal direction. Furthermore, first linear crazes or cracks with an angle of 45° relative to the longitudinal direction of the film were formed by passing the film through at a 45° angle relative to the axis of the bending roll 8 in such a way that the first notches and the axial direction of the bending roll 8 were positioned in parallel. Also, second linear crazes at a 25 μm pitch, angled at −45° relative to the film longitudinal direction, were induced by similarly passing the film through the device at a −45° angle relative to the film take-up direction. The resulting bi-directional linear crazes were approximately perpendicular to one another, and lattice-shaped crazes comprising crazes intersecting in two directions were formed on the film. During this series of processes, transport speed was 40 cm/min and the tension was 5 N/cm. The bending roll 8 diameter was 4 mm.

Next, tension was temporarily relaxed and the transport direction was changed to be parallel to the longitudinal direction of the film, following which the film was introduced into the craze filling device 20 shown in FIG. 2. The immersion bath 26 in the craze filling device 20 was filled with Emacol Black C carbon black nano water dispersion fluid manufactured by the Sanyo Pigment Co., and the temperature thereof was maintained at 20° C. The immersion distance of the film was set at 40 cm. (Immersion time: 1 minute) Thereafter excess liquid was removed using a doctor blade, and moisture was removed by passage through a heating device 36 blowing 80° C. hot air to obtain a light regulating film in which carbon black was introduced into the crazes thereof.

The completed light regulating film exhibited superior transmissivity and sharp visual field control, with a transmissivity of 78% when parallel beams were made perpendicularly incident to the film surface and, for an incidence of 60° to the film surface from directions parallel to the respective craze forming directions, a transmissivity of 1.3% when parallel to the first craze forming direction and 1.4% when parallel to the second craze forming direction.

### Working Example 5

The film having first linear crazes at a 25 μm pitch fabricated in Working Example 2 was again passed over a 4 mm diameter deforming roll 8 in the continuous direction of the film under a tension of 7 N/cm and a transport speed of 20 cm/min using the device of FIG. 1 without the drum 6, then bent perpendicularly relative to the first crazes and passed through the deforming roll 8 while being deformed at 170°, such that second crazes could be formed which, while not perfectly regular as in Working Example 1, had an average pitch of approximately 30 μm, starting at the first crazes and approximately perpendicular to the first crazes. This film was successfully continuously fabricated.

As in the Working Example 1, carbon black was filled into the crazes to form a light regulating film. The completed light regulating film exhibited superior transmissivity and sharp visual field control, with a transmissivity of 79% when parallel beams were made perpendicularly incident to the film surface and, for an incidence of 60° to the film surface from directions parallel to the respective craze forming directions, a transmissivity of 1.2% when parallel to the first craze forming direction and 1.9% when parallel to the second craze forming direction.

### Working Example 6

A solution of methacrylic resin (Mitsubishi Rayon, Acrylite L) dissolved in methyl ethyl ketone was coated onto a 50 μm thick, 10 cm wide polyester film using a bar coater, then dried to produce a compound film with a 150 μm thick methacrylic resin coating membrane; using this compound film as the film material 2, a light regulating film (louvered film) was manufactured with the manufacturing device 1 shown in FIG. 3.

Crazes starting at notch patterns were formed by bending a film material in which a notch pattern had been imparted by the drum 6 along the bending roll 8 to apply flexural stress in an immersion liquid using heat-hardening paint as a liquid material and carbon black as a filling substance. A light regulating film was then obtained by heat-hardening the black paint.

Processing conditions in this case were an uptake speed of 25 cm/min, a tension of 15 N/cm (tension per unit film width), and an immersion temperature of 15° C. The diameter of the bending roll 8 was 6 mm.

The completed film exhibited extremely sharp visual field control, with a transmissivity of 80% when parallel beams were made perpendicularly incident to the film surface, and a transmissivity of 0.5% for an incidence of 60° to the film surface.

### Working Example 7

A sheet louvered film (light regulating film) was fabricated in the same manner as in Working Example 6, except that a 0.4 mm thick, 10 cm wide acrylic resin plate was used instead of a polyester film coated with methacrylic resin, and a 200 μm pitch was used for the notch pattern.

The completed louvered film exhibited extremely sharp visual field control, with a transmissivity of 83% when parallel beams were made perpendicularly incident to the film surface, and a transmissivity of 0.2% for an incidence of 60° to the film surface.

### Working Example 8

Using the polyester film with a 50 μm thick methacrylic resin coating membrane fabricated in Working Example 6, a louvered film (light regulating film) was fabricated by the same method as in Working Example 6, except that instead of the drum 6 of the manufacturing device 1 in the above embodiments, an aluminum foil mask with 2 μm wide slits punched through it at a 25 μm pitch was used to cover a film material, and ultraviolet rays were irradiated from above using a high pressure mercury lamp.

At this point, the notch pattern formed had widened to 5 μm relative to the 2 μm mask pattern. The crazes or cracks thus formed cannot be called continuous, but they were selectively formed within the notch pattern.

The completed louvered film exhibited extremely sharp visual field control, with a transmissivity of 81% when parallel beams were made perpendicularly incident to the film surface, and a transmissivity of 0.4% for an incidence of 60° to the film surface.

### Working Example 9

Using the polyester film with a 50 μm thick methacrylic resin coating membrane fabricated in Working Example 6, a louvered film (light regulating film) was fabricated by the same method as in Working Example 6, except that instead of the impressing the film on the drum 6 of the manufacturing device 1 as in the embodiment above, 2-butanone was printed at a 3 μm width and a 25 μm pitch using an ink jet head.

At this point, the notch pattern formed had widened to 4 μm, although the printed setting for forming the mask pattern was 2 μm. As in Working Example 12, the crazes or cracks thus formed cannot be called continuous, but they were selectively formed within the notch pattern.

The completed louvered film exhibited extremely sharp visual field control, with a transmissivity of 79% when parallel beams were made perpendicularly incident to the film surface, and a transmissivity of 0.4% for an incidence of 60° to the film surface.

### Working Example 10

A louvered film (light regulating film) was fabricated in the same way as in Working Example 1, except that a solution of fluorine polymer (refractive index nD: 1.38) comprising vinylidene chloride and tetrafluoroethylene copolymerized in a ratio of 80:20 by weight dissolved in ethyl acetate was used instead of the heat-hardening paint with carbon black of Working Example 1, and the liquid temperature was set at 5° C.

The completed louvered film exhibited relatively bright and sharp field visual control, with a transmissivity of 72% when parallel beams were made perpendicularly incident to the film surface, and a transmissivity of 7.0% for an incidence of 60° to the film surface.

### Working Example 11

Using the polyester film with a 50 μm thick methacrylic resin coating membrane fabricated in Working Example 6, a compound film was fabricated by a [method] which, although a batch process, placed an aluminum foil mask from which 20 cm long, 2 μm wide slits were punched out at a 25 μm pitch over a film material so that the direction of the slits was approximately perpendicular to the direction of film transport, and irradiated the film with 20 cm long from above with ultraviolet light with a high pressure mercury lamp, rather than physically imparting a notch pattern using the manufacturing device 1 drum 6 as in the embodiment above.

A compound film containing crazes or cracks extending approximately perpendicular to the direction of film transport was obtained by passing the above compound film over a 4 mm diameter bending roll 8 at a temperature of 20° C. and processing at a transport speed of 50 cm/min under a tension of 10 N/cm per unit length.

At this point, the width of the notch pattern formed had widened to approximately 5 μm relative to the mask pattern width of 2 μm. FIG. 11 shows a micrograph of the crazes or cracks formed. The crazes or cracks could not be called continuous, but they did stay selectively within the notch pattern.

Next, the compound film in which crazes or cracks were formed was immersed in a 17° C. immersion bath 26 containing water-dispersible carbon black (manufactured by Tokai Carbon Co.) and caused to pass through the bath at a transport speed of 20 cm/min under a tension of 0.5 N/cm such that the polyester surface contacted the 10 mm diameter guide roller.

The completed louvered film exhibited extremely sharp field visual control, with a transmissivity of 79% when parallel beams were made perpendicularly incident to the film surface, and a transmissivity of 0.4% for an incidence of 60° to the film surface.

### Working Example 12

Using the polyester film with a 50 μm thick methacrylic resin coating membrane fabricated in Working Example 6, 1000 grit sandpaper was used to form a dot-shaped notch pattern by pressing the sandpaper into the film, in place of the drum 6 on the above manufacturing device 1.

This compound film was passed over a 4 mm diameter bending roll 8 at 20° C. and processed at a transport speed of 50 cm/min under a tension of 10 N/cm per unit length to obtain a compound film containing crazes or cracks.

A micrograph of the crazes or cracks formed at this time is shown in FIG. 12. It is clear that while not so for all of the crazes or cracks, formation of crazes or cracks selectively occurs starting at the dot-shaped notch patterns.

Next, the compound film in which crazes or cracks were formed was immersed in a 17° C. immersion bath 26 containing water-dispersible carbon black (manufactured by Tokai Carbon Co.) and caused to pass through the bath at a transport speed of 20 cm/min under a tension of 0.5 N/cm, such that the polyester surface contacted the 10 mm diameter guide roller.

### Working Example 13

Using a compound film similar to that of Working Example 12, half the surface of the compound film was pressed into 1000 grit sandpaper, while the other half surface was into 500 grit sandpaper to form dot-patterned notches. When 500 grit sandpaper was used, the density of the dot pattern was half that achieved with 1000 grit.

A compound film containing crazes or cracks was obtained by passing this film over a 4 mm diameter roll bending roll 8 at a temperature of 20° C., processing at a transport speed of 50 cm/min under a tension of 8 N/cm per unit length. As shown in FIGS. 13 and 14, the density of crazes or cracks was also nearly halved on the side on which notches were imparted using the 500 grit sandpaper.

### Working Example 14

Using the polyester film with a 50 μm thick methacrylic resin coating membrane fabricated in Working Example 6, a compound film with a 20 cm long notch pattern was fabricated by a method which, although by batch processing, placed an aluminum foil mask with 5 μm wide and 20 cm long slits punched out at a 50 μm pitch over a film material so that the direction of the slits was approximately 45° relative to the direction of film transport, irradiating ultraviolet light thereon from above using a high pressure mercury lamp, rather than physically imparting notch patterns using the drum 6 of the manufacturing device 1 in the embodiment above.

A compound film containing crazes or cracks was obtained by passing the above compound film over a 4 mm diameter bending roll 8 at a temperature of 20° C. and processing at a transport speed of 50 cm/min under a tension of 10 N/cm per unit length.

At this point, the width of the notch pattern formed had widened to approximately 10 μm relative to the 5 μm mask pattern. The crazes or cracks formed were not continuous, but rather were very fine crazes or cracks arrayed in a direction 45° relative to the direction of transport, along the notch pattern. FIG. 15 shows a micrograph taken at this time. Dimly visible at the 45° angle is the notch pattern imparted by the ultraviolet beam; very fine crazes or cracks can be confirmed along those patterns.

### Working Example 15

Using the polyester film with a 50 μm thick methacrylic resin coating membrane fabricated in Working Example 6, a compound film with a 20 cm long notch pattern was fabricated by placing an aluminum foil mask from which 20 cm long and 2 μm wide slits were punched out at a 25 μm pitch over a film material so that the direction of the slits was parallel to the direction of film transport, irradiating ultraviolet light thereon from above using a high pressure mercury lamp, rather than by the drum 6 of the manufacturing device 1 in the embodiment above.

A compound film with crazes or cracks was obtained by passing the above compound film over a 4 mm diameter bending roll 8 at 20° C. and processing at a transport speed of 50 cm/min and a tension of 12 N/cm per unit length.

At this point, the notch pattern formed had widened to 5 μm relative to the 2 μm mask pattern. FIG. 16 shows a micrograph of the crazes or cracks formed. Crazes or cracks were formed continuously, in a direction approximately perpendicular to the direction in which the notch pattern was formed.

Next, the compound film was immersed in a 17° C. immersion bath 26 containing water-dispersible carbon black (manufactured by Tokai Carbon Co.) and caused to pass through the bath at a transport speed of 20 cm/min under a tension of 0.5 N/cm, such that the polyester surface contacted the 10 mm diameter guide roller.

The completed louvered film exhibited extremely sharp visual field control, with a transmissivity of 72% when parallel beams were made perpendicularly incident to the film surface, and a transmissivity of 0.4% for an incidence of 60° to the film surface.

### Working Example 16

Using a 100 μm pitch mask pattern, a compound film in which crazes or cracks were formed and a compound film containing carbon cracks were prepared in the same way as in Working Example 15, except that a 6 mm diameter bending roll 8 was used.

Depending on location, some of the crazes or cracks formed were discontinuous.

The competed louvered film had a transmissivity of 73%; when incidence was 60° to the film surface, transmissivity was 0.6%.

### Comparative Example

Crazes were generated and a carbon black-containing film was fabricated under the same conditions as in Working Example 1, except that the process of imparting notch patterns was omitted, and a 30° peak angle circular stainless blade with an approximately 100 μm blade tip diameter was used in place of the bending roll 8 of the manufacturing device 1.

Transmissivity was insufficient in the completed film, at 60% when parallel beams were made perpendicularly incident to the film surface, and 1% for an incidence of 60° to the film surface.

### BRIEF DESCRIPTION OF FIGURES

FIG. 1 A summary diagram showing a portion of a light regulating film manufacturing device in a first embodiment of the present invention.

FIG 2 A summary diagram showing a portion of a light regulating film manufacturing device in a first embodiment of the present invention.

FIG 3 A summary diagram showing a portion of a light regulating film manufacturing device in a second embodiment of the present invention.

FIG 4 A summary diagram showing a portion of a light regulating film manufacturing device in a third embodiment of the present invention.

FIG 5 A diagram showing a light regulating film notch pattern and craze-forming pattern in a third embodiment of the present invention.

FIG 6 A diagram showing a light regulating film craze or crack forming pattern in a fourth embodiment of the present invention.

FIG 7 A diagram showing a portion of a light regulating film manufacturing device in a fifth embodiment of the present invention.

FIG 8 A diagram showing a light regulating film craze or crack forming pattern in a fifth embodiment of the present invention.

FIG 9 A diagram explaining a method for evaluating film field visual control in a Working Example or the like of the present invention.

FIG 10 A diagram showing a light regulating film craze forming pattern in Working Example 3 of the present invention.

FIG 11 A diagram showing a light regulating film craze forming pattern in Working Example 11 of the present invention.

FIG 12 A diagram showing a light regulating film craze forming pattern in Working Example 12 of the present invention.

FIG 13 A diagram showing a craze forming pattern when 1000 grit sandpaper was used to form a notch pattern in Working Example 13 of the present invention.

FIG. 14 A diagram showing a craze forming pattern when 500 grit sandpaper was used to form a notch pattern in Working Example 13 of the present invention.

FIG 15 A diagram showing a light regulating film craze forming pattern in Working Example 14 of the present invention.

FIG 16 A diagram showing a light regulating film craze forming pattern in Working Example 15 of the present invention.

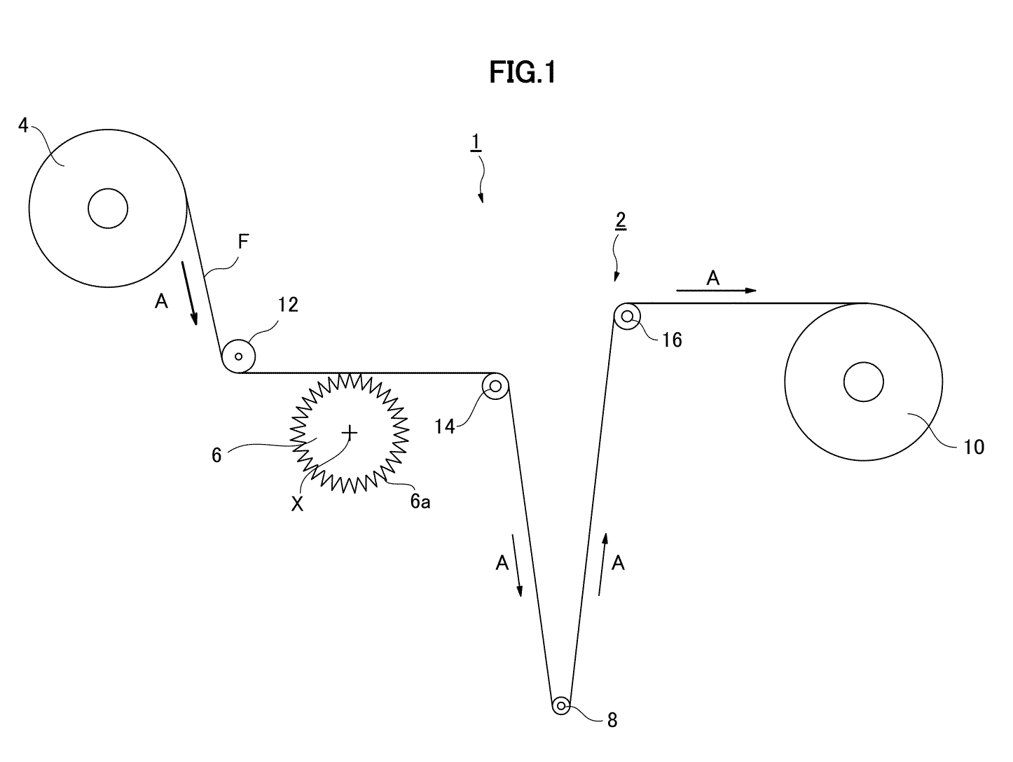

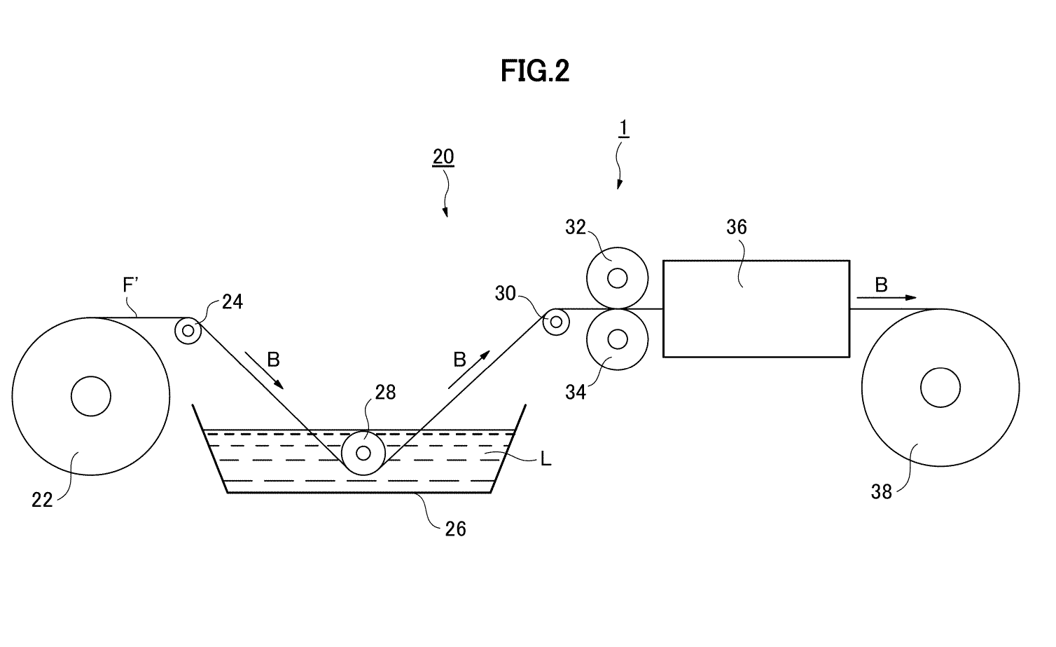

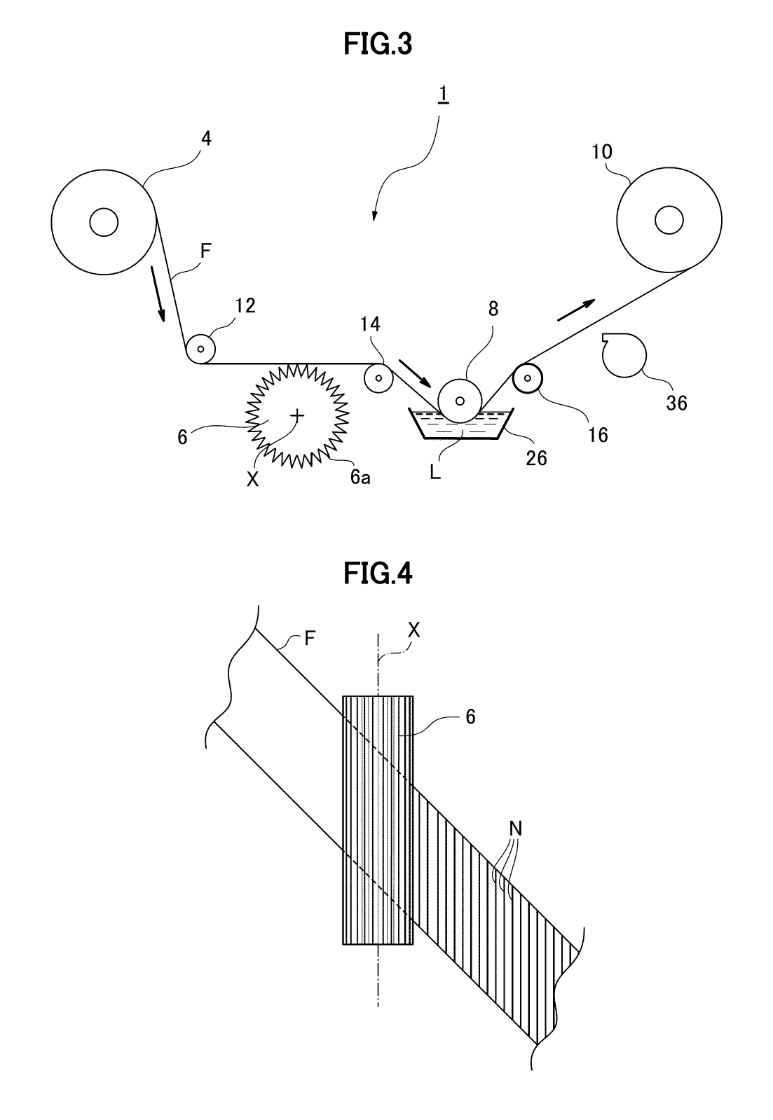

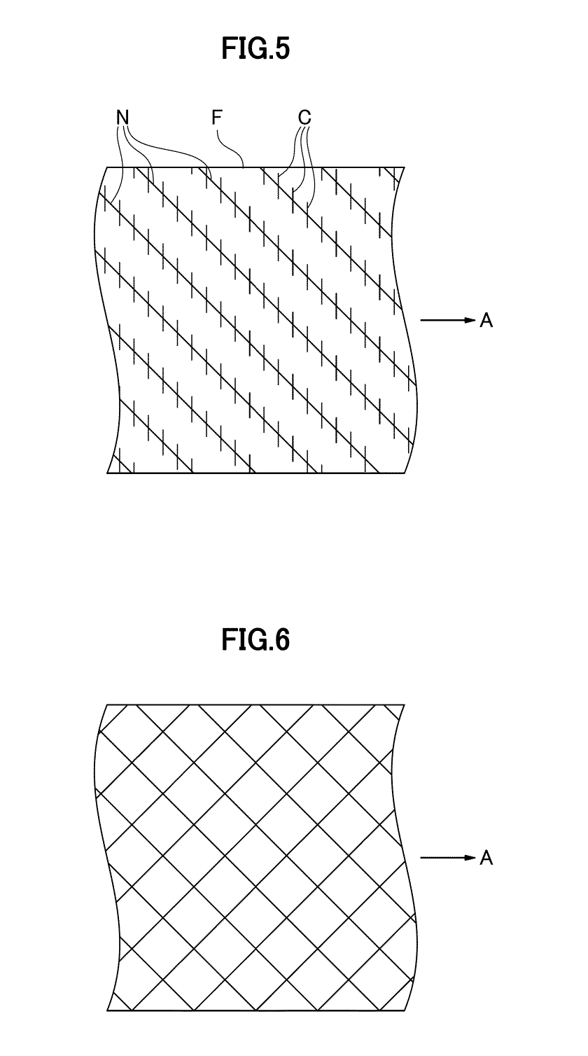

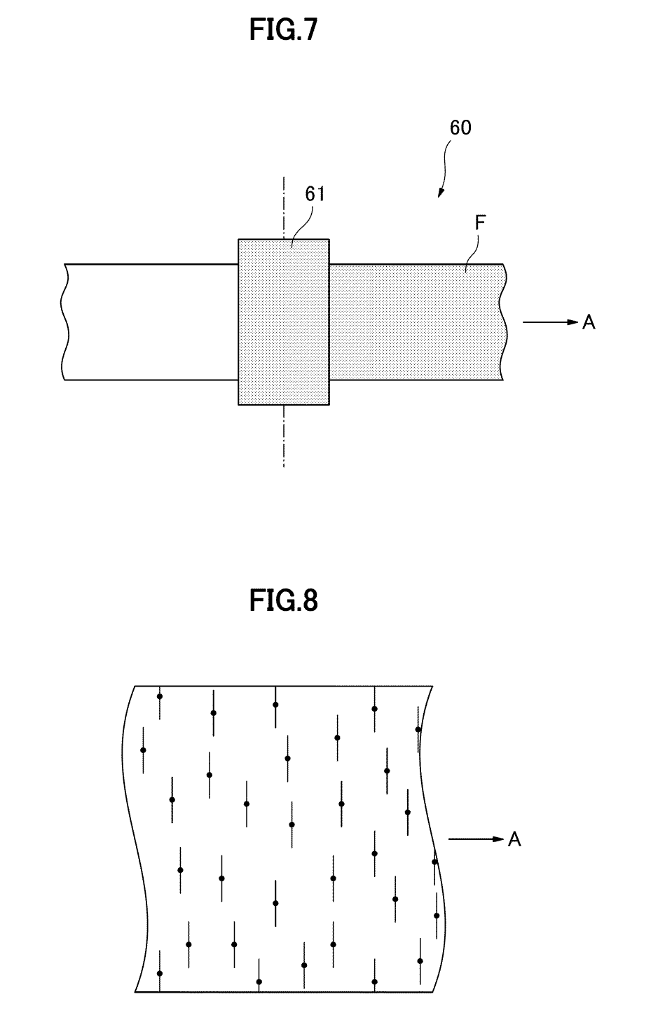

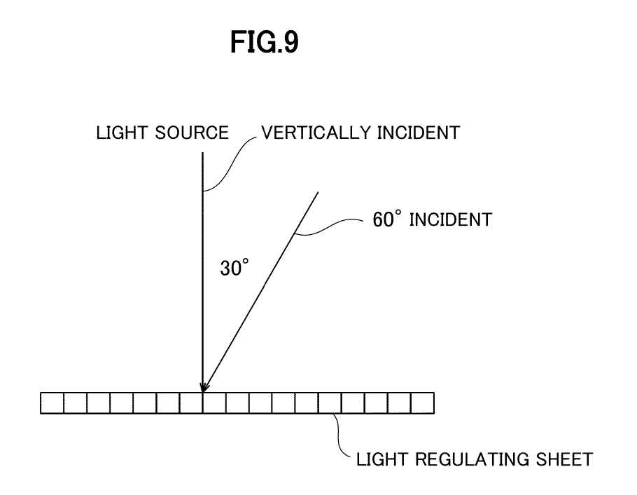

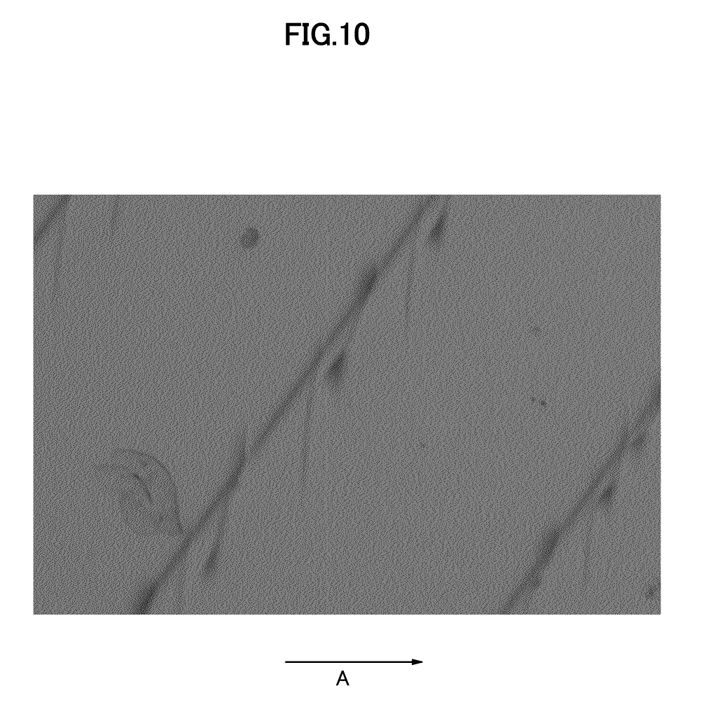

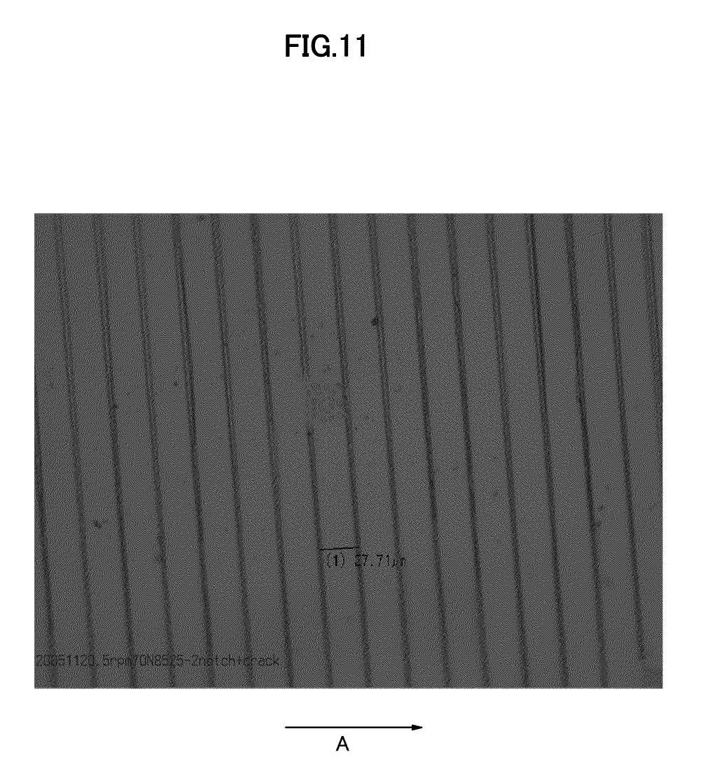

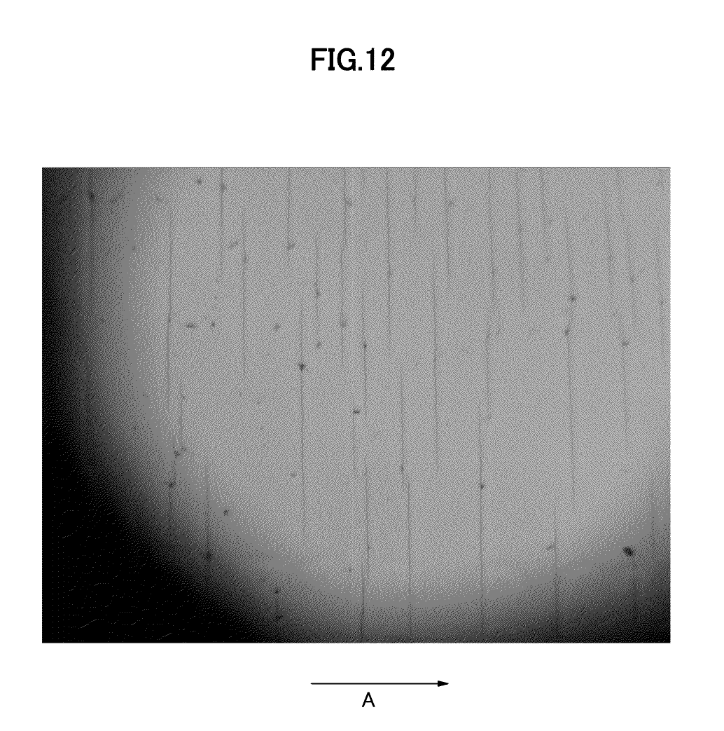

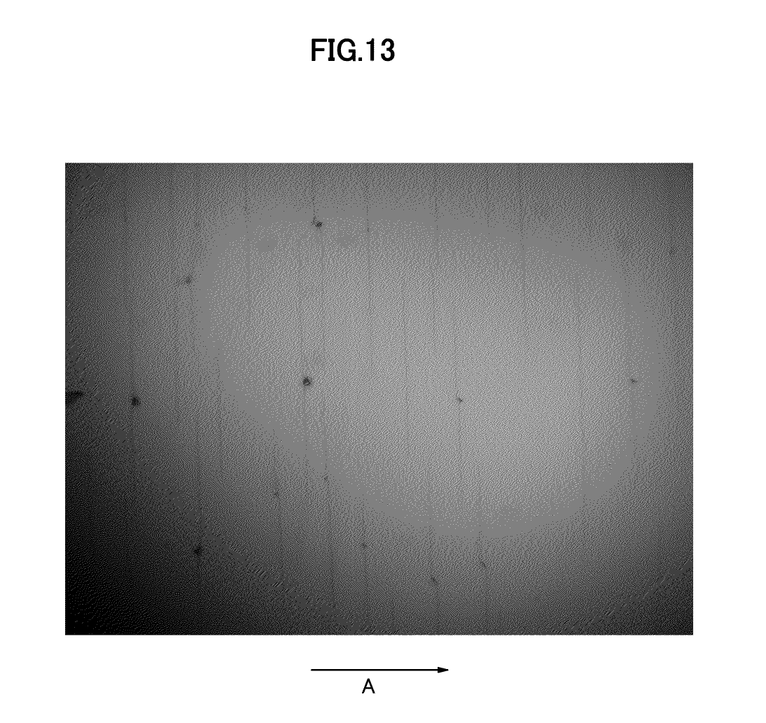

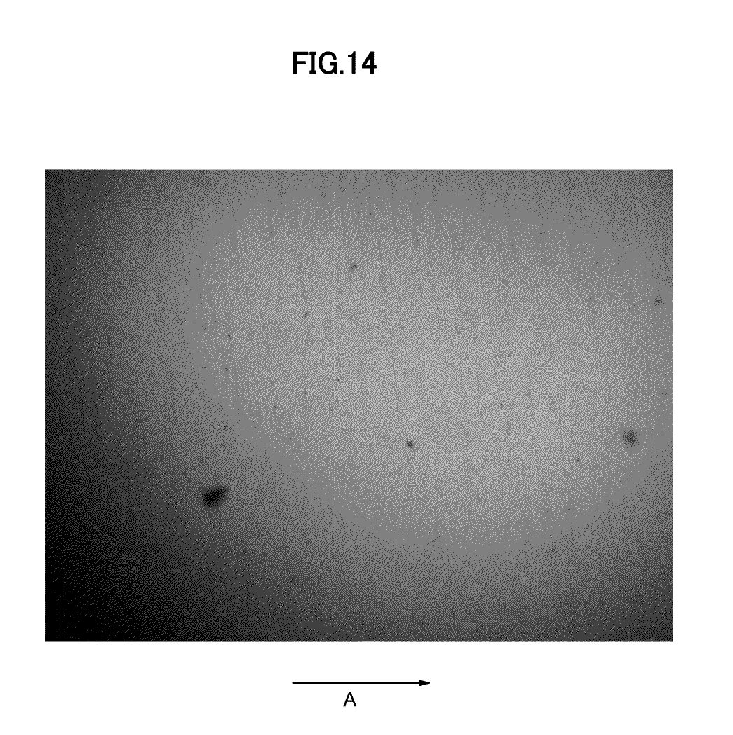

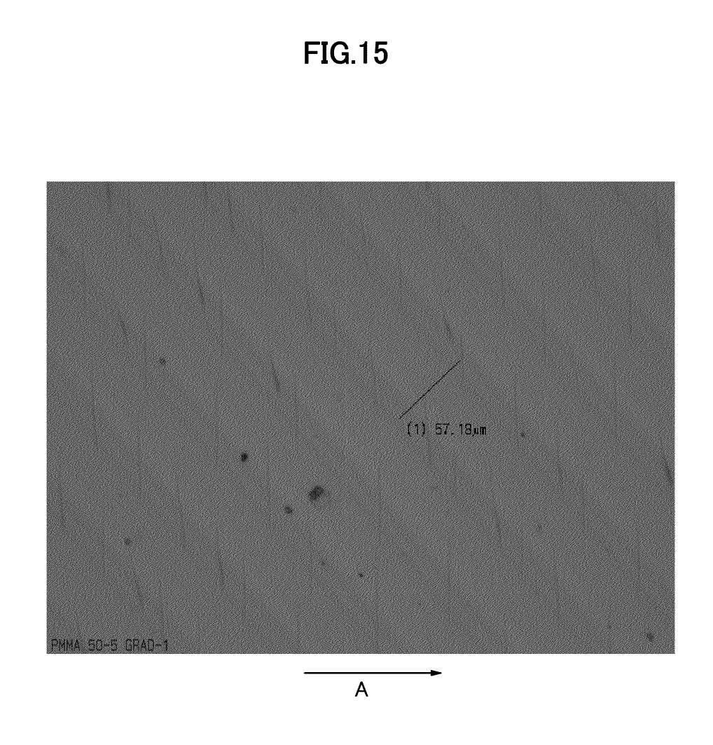

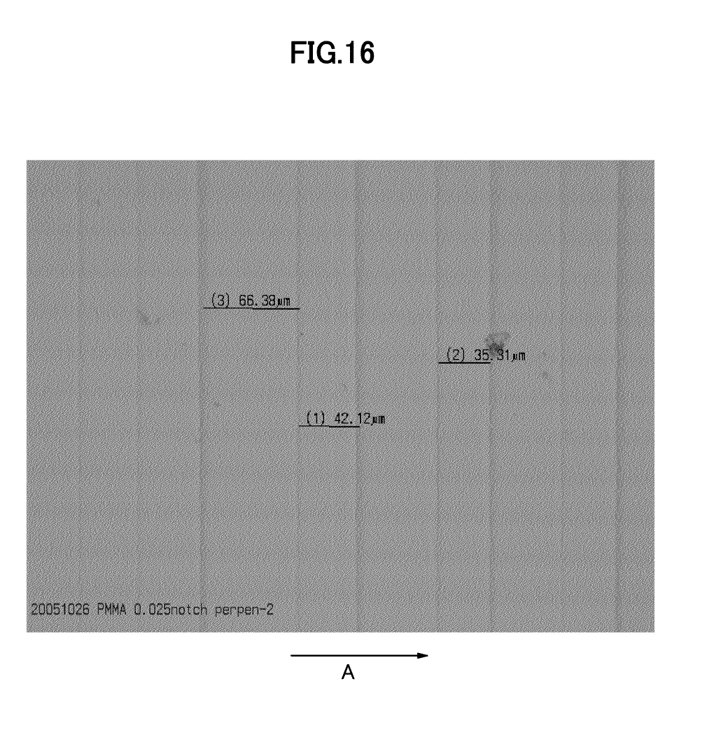

### EXPLANATION OF REFERENCE NUMERALS

1: Light regulating film manufacturing device
2: Craze forming device
6: Drum
8: Bending roll
10: Take-up roll
20: Craze filling device
22: Supply roll
26: Immersion bath
32, 34: Cleaning roll
36: Heating device
F: Film
F′: Film with crazes
L Liquid material
A: Transport direction

1. A method for producing a light regulating film comprising a step for forming a plurality of starting point portions in a predetermined pattern on the surface of a film material, and a step for forming crazes or cracks starting from the starting point portions.

2. The method for producing a light regulating film of claim 1, wherein the step for forming the starting point portions is a step in which a mold corresponding to starting point portions is impressed on the surface of the film material.

3. The method for producing a light regulating film of claim 2, wherein the mold is a drum with protuberances formed on its outer circumference.

4. The method for producing a light regulating film of claim 1, wherein the step for forming the starting point portions is one in which scars are made in the film material using blades corresponding to starting point portions.

5. The method for producing a light regulating film of claim 1, wherein the step for forming the starting point portions is one in which properties of the parts of the film material corresponding to the starting point portions are varied.

6. The method for producing a light regulating film of claim 5, wherein the step for varying the properties includes a step for covering the film material with a mask and irradiating the film with electromagnetic radiation.

7. The method for producing a light regulating film of claim 5, wherein the step for varying the properties includes a step for adhering an organic solvent to the parts corresponding to the starting point portions on the surface of the film material.

8. The method for producing a light regulating film of claim 1, wherein the starting point portions are dots.

9. The method for producing a light regulating film of claim 1, wherein the starting point portions are linear.

10. The method for producing a light regulating film of claim 9, wherein the film material is of an elongated shape, and the linear starting point portions extend in the longitudinal direction of said elongated film material.

11. The method for producing a light regulating film of claim 9, wherein the film material is of an elongated shape, and the linear starting point portions extend at an angle relative to the longitudinal direction of said elongated film material.

12. The method for producing a light regulating film of claim 1, wherein the step for forming the crazes or cracks is achieved by applying flexural stress while applying tension to the film material.

13. The method for producing a light regulating film of claim 12, wherein the starting point portions are linear and the step for forming the crazes or cracks includes a step for applying flexural stress to the film material in a direction approximately perpendicular to the direction in which the linear starting point portions extend.

14. The method for producing a light regulating film of claim 12, wherein the starting point portions are linear and the step for forming the crazes or cracks includes a step for applying flexural stress to the film material in a direction approximately parallel to the direction in which the linear starting point portions extend.

15. The method for producing a light regulating film of claim 12, wherein the starting point portions are linear and the step for forming crazes or cracks includes a process for applying flexural stress to the film material in a direction intersecting the direction in which the linear starting point portions extend.

16. The method for producing a light regulating film of claim 1, wherein the step for forming the starting point portions includes a step for forming first starting point portions and a step for forming second starting point portions;
and the step for forming the crazes or cracks includes a step for forming first crazes or cracks starting from the first starting point portions, and a step for forming second crazes or cracks starting from the second starting point portions and extending in a direction intersecting the first crazes or cracks.

17. The method for producing a light regulating film of claim 1, further comprising a step whereby, using the crazes or cracks as a starting point, second crazes or cracks are formed, extending in a direction intersecting the direction in which said crazes or cracks extend.

18. The method for producing a light regulating film of claim 1, wherein the film material has an Izod impact strength (ASTM D256) of not more than 40 J/m, a flexural modulus (ASTM D790) of not less than 2950 Mpa, and a thickness of not more than 0.35 mm;
and wherein the crazes or cracks are formed by application of flexural deformation using a bending radius r/d<30 (r=bending radius; d=film material thickness) under a tension of not more than 10 N/cm.

19. The method for producing a light regulating film of claim 1, further comprising a step for filling the crazes or cracks with a substance having optical properties different from those of the film material.

20. The method for producing a light regulating film of claim 19, wherein the step for filling using a substance with differing optical properties includes a step for immersing the film material in a liquid material containing a substance having optical properties different from those of the film material.

21. The method for producing a light regulating film of claim 19, wherein the step for forming crazes or cracks is performed in a state whereby film material is immersed in a liquid material containing a substance having optical properties different from those of the film material.

22. A method for producing a laminated light regulating film comprising a step for laminating a base material film and the light regulating film produced by the light regulating film producing methods in any one of claims 1 to 21.
